(19) United States
(12) Patent Application Publication
(10) Pub. No.: US 2025/0174217 A1
(43) Pub. Date: May 29, 2025

(54) HORN SYSTEM FOR VEHICLE

(71) Applicant: TOYOTA JIDOSHA KABUSHIKI KAISHA, Toyota-shi (JP)

(72) Inventor: Shuichi ASO, Toyota-shi (JP)

(21) Appl. No.: 18/932,640

(22) Filed: Oct. 31, 2024

(30) Foreign Application Priority Data
Nov. 24, 2023 (JP) 2023-199405

(51) Int. Cl. G10K 11/02; B60Q 5/00

(52) U.S. Cl. CPC G10K 11/02; B60Q 5/00

(57) ABSTRACT

A vehicle horn system including a horn provided at a vehicle and a cooling part that cools the horn is provided.

### CROSS-REFERENCE TO RELATED APPLICATION

This application is based on and claims priority under 35 USC 119 from Japanese Patent Application No. 2023-199405, filed on Nov. 24, 2023, the disclosure of which is incorporated by reference herein.

### BACKGROUND

### Technical Field

The present disclosure relates to a vehicle horn system.

### Related Art

A horn device which can prevent malfunction while generating a warning sound by performing intermittent operation in a predetermined temperature range, is conventionally known (for example, see Japanese Patent Application Laid-open No. 2021-021819).

As the internal temperature of the horn increases, the sound pressure decreases. Therefore, although intermittent operation is performed in a predetermined temperature range, intermittent operation results in a discontinuous state of interrupted sound owing to the existence of times of non-operation. In other words, sound quality defects occur.

### SUMMARY

Accordingly, the present disclosure is to provide a horn system for a vehicle which may suppress a decrease in sound pressure without causing a sound quality defect.

A vehicle horn system according to a first aspect of the present disclosure includes: a horn provided at a vehicle; and a cooling part that cools the horn.

According to the first aspect, a horn provided in a vehicle is cooled by a cooling part. Therefore, an increase in the internal temperature of the horn is suppressed, and a decrease in sound pressure is suppressed without causing a sound quality defect.

Further, a vehicle horn system according to a second aspect of the present disclosure is the vehicle horn system of the first aspect, in which the horn includes: a housing; and a coil that generates a magnetic force upon being supplied with electric power, and the cooling part is disposed between the housing and the coil.

According to the second aspect, the cooling part is interposed between the housing and the coil, which is powered to generate a magnetic force. Therefore, the coil is efficiently heat-exchanged with the housing and the outside air, and is cooled. In other words, an increase in the internal temperature of the horn is effectively suppressed, and a decrease in the sound pressure is effectively suppressed.

Further, a vehicle horn system of a third aspect of the present disclosure is the vehicle horn system of the second aspect, in which the cooling part includes a Peltier element, and a heat radiation side of the Peltier element contacts the housing, and a heat absorption side of the Peltier element contacts the coil.

According to the third aspect, the heat radiation side of the Peltier element serving as the cooling part contacts the housing, and the heat absorption side of the Peltier element contacts the coil. As a result, the coil is effectively cooled.

Further, a vehicle horn system according to a fourth aspect of the present disclosure is the vehicle horn system according to the second or third aspect, further including: a controller that is configured to control the cooling part; and a temperature sensor that detects a temperature of the coil, in which the controller effects control so as to cool the horn in a case in which the temperature of the coil detected by the temperature sensor has become equal to or higher than a predetermined temperature.

According to the fourth aspect, the controller, which controls the cooling part, effects control so as to cool the horn when the temperature of the coil detected by the temperature sensor becomes equal to or higher than the predetermined temperature. Therefore, the temperature required to secure the sound pressure may be efficiently controlled.

Further, a vehicle horn system of a fifth aspect of the present disclosure is the vehicle horn system of the fourth aspect, in which the temperature sensor is disposed at an opposite side of the coil from the cooling part.

According to the fifth aspect, the temperature sensor is arranged on the opposite side of the coil from the cooling part with the coil interposed therebetween. Therefore, as compared to a case in which the temperature sensor is arranged on the same side as the cooling part, the temperature necessary for securing the sound pressure may be appropriately detected.

In this way, according to the present disclosure, reduction in sound pressure may be suppressed without causing sound quality defects.

### BRIEF DESCRIPTION OF THE DRAWINGS

FIG. 1 is a schematic configuration diagram illustrating a vehicle horn system according to the present embodiment.

FIG. 2 is a schematic front view illustrating a horn of the vehicle horn system according to the present embodiment.

FIG. 3 is a schematic cross-sectional view taken along line X-X of FIG. 2.

FIG. 4 is a graph illustrating the operation of the vehicle horn system according to the present embodiment.

FIG. 5 is a flowchart illustrating the operation of the vehicle horn system according to the present embodiment.

### DETAILED DESCRIPTION

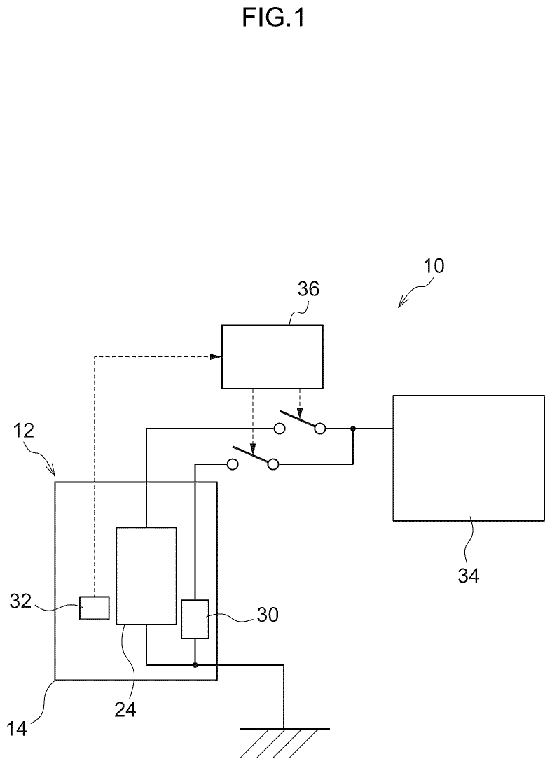

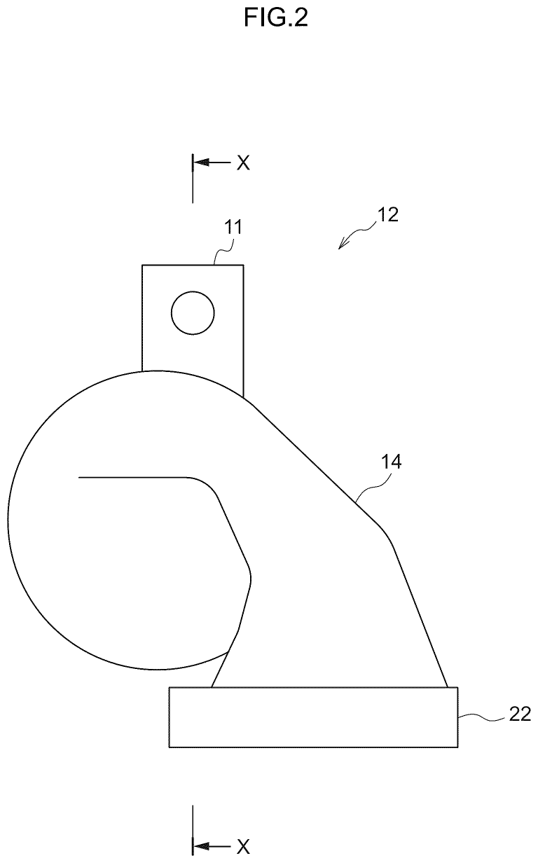

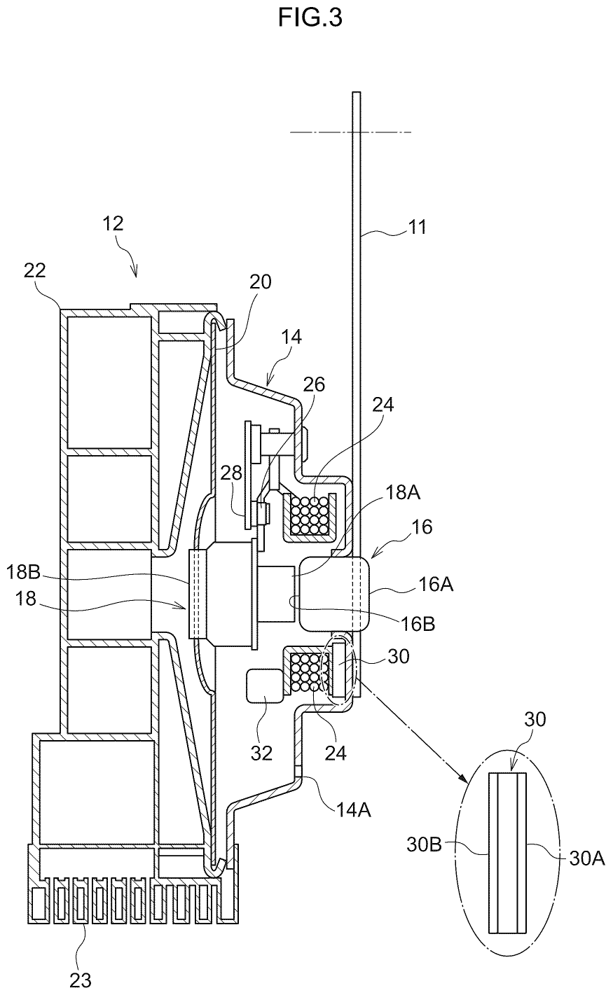

Hereinafter, embodiments of the present disclosure will be described in detail based on the drawings. A vehicle such as an electric vehicle (not illustrated) is equipped with a vehicle horn system 10 as illustrated in FIG. 1. The vehicle horn system 10 includes a horn 12 illustrated in FIG. 2. As illustrated in FIGS. 2 and 3, the horn 12 includes a metal housing 14 having a substantially hollow truncated cone shape, and one side, in an axial direction, of the housing 14 is attached to a plate-shaped stay 11.

As illustrated in FIG. 3, an axial center part on one axial direction side of the housing 14 is provided with an end part 16A on the one axial direction side of a core 16 that is an electromagnet, and a moving bolt 18 is provided on the other axial direction side of the housing 14 relative to the core 16. More specifically, an end surface 18A of the moving bolt 18 on the one axial direction side faces an end surface 16B of the core 16 on the other axial direction side with a predetermined gap therebetween.

A disk-shaped diaphragm 20 is coaxially attached to the other axial direction side end part 18B of the moving bolt 18, and on the other side of the diaphragm 20 in the axial direction, a resonance tube 22 which resonates and amplifies vibration (sound) is arranged in opposition at a predetermined interval. Note that a metal heat dissipation part 23, which has a function of preventing entry of foreign matter, is integrally attached to at least a part of the resonance tube 22 shown in the drawing.

Furthermore, a coil 24 which generates a magnetic force upon being supplied with electric power is provided around the core 16 and the moving bolt 18 in the housing 14. The configuration is such that the coil 24 generates a magnetic force upon being supplied with electric power, whereby the core 16 is magnetized. Then, the moving bolt 18 is attracted to the magnetized core 16 and collides with the core 16, vibration (sound) generated at the time of collision is transmitted to the resonance tube 22 via the diaphragm 20, and this vibration (sound) is resonated and amplified by the resonance tube 22.

Note that when the moving bolt 18 is attracted to the core 16, the diaphragm 20 has a function of generating an urging force (elastic restorative force) for returning the moving bolt 18 to its original position. Furthermore, a breathing hole 14A is formed in a predetermined position in the housing 14 so that vibration of the diaphragm 20 is not inhibited.

Furthermore, a contact point 26 for turning on/off the electric power supply to the coil 24 is provided in the housing 14. The contact point 26 is connected to the moving bolt 18, is normally closed and supplying power to the coil 24, and is configured such that when the moving bolt 18 moves toward the one direction axial side, it opens and the power supply to the coil 24 is interrupted. A terminal 28 for power supply is connected to the contact point 26.

In the housing 14 of the horn 12 configured as described above, a Peltier element 30 as a cooling part for cooling the coil 24 and a temperature sensor 32 for detecting the temperature of the coil 24 are provided. Since, as illustrated in an enlarged manner in FIG. 3, the Peltier element 30 is powered to cause a temperature difference between the one surface 30A and the other surface 30B and thereby effect cooling, it is interposed between the housing 14 and the coil 24.

In other words, the Peltier element 30 is arranged so that its heat radiation side surface 30A contacts the housing 14, and its heat absorption side surface 30B contacts the coil 24. While not illustrated, a power supply terminal is also provided in the Peltier element 30. Further, the temperature sensor 32 is arranged on the opposite side of the coil 24 from the Peltier element 30 with the coil 24 interposed therebetween, and arranged contiguously to the coil 24.

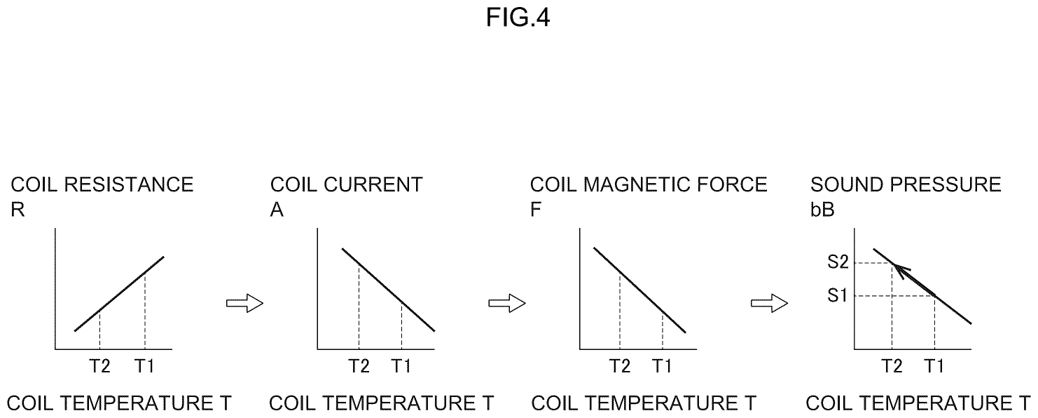

As illustrated in FIG. 1, electricity is supplied from an auxiliary battery 34 installed in a vehicle to the coil 24 and the Peltier element 30 of the horn 12 configuring the vehicle horn system 10. Further, the vehicle is equipped with a controller 36 which controls power supply to the coil 24 and the Peltier element 30, and the controller 36 is electrically connected to the temperature sensor 32. In other words, when the temperature of the coil 24 detected by the temperature sensor 32 becomes equal to or higher than a predetermined temperature (threshold value T1: see FIG. 4), a command (signal) for cooling the coil 24 is issued. Note that the controller 36 may be a processor or the like.

In the vehicle horn system 10 according to the present embodiment configured as described above, the operation thereof will be described next.

As illustrated in FIG. 4, when the temperature of the coil 24 increases, the resistance of the coil 24 increases. When the resistance of the coil 24 increases, the current flowing through the coil 24 decreases, such that the magnetic force generated in the coil 24 decreases. When the magnetic force generated by the coil 24 decreases, the sound pressure of the sound generated by the horn 12 decreases.

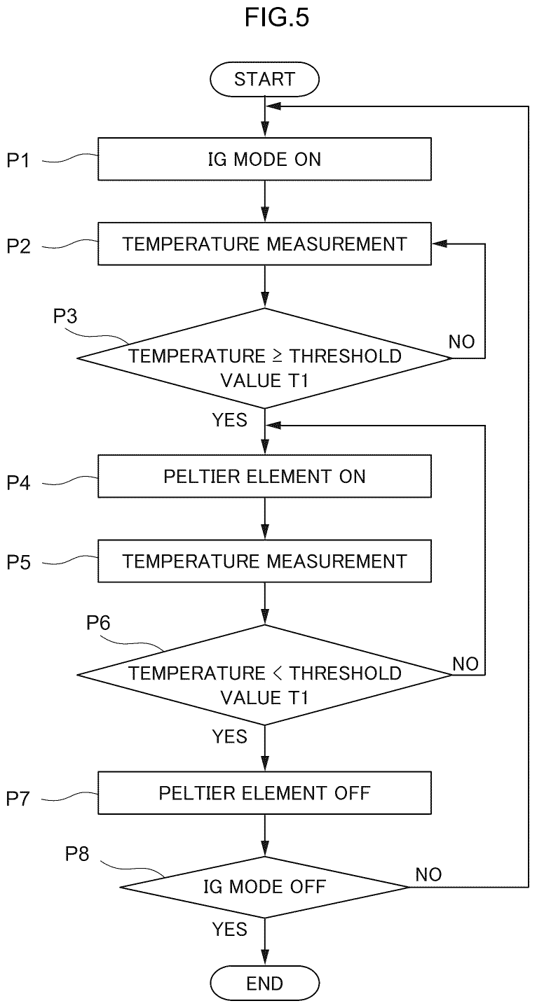

Therefore, in the present embodiment, when the temperature of the coil 24 becomes equal to or greater than the threshold T1, the coil 24 is cooled. According to this, for example, when the temperature of the coil 24 is cooled from T1 to T2, the sound pressure may be increased from S1 to S2. Hereinafter, control for cooling the coil 24 will be described based on the flowchart illustrated in FIG. 5.

As illustrated in FIG. 5, after the ignition (IG) mode is turned ON in step P1, in step P2, the temperature of the coil 24 is detected by the temperature sensor 32. Then, in step P3, it is determined by the controller 36 whether or not the temperature is equal to or greater than the threshold value T1, and in a case in which it is determined that the temperature is less than the threshold value T1, the process returns to step P2 again, and the temperature of the coil 24 is detected.

On the other hand, in step P3, in a case in which the temperature is determined to be equal to or higher than the threshold value T1 by the controller 36, in step P4, power is supplied to the Peltier element 30 as a result of control by the controller 36, and the coil 24 is cooled. Then, in step P5, the temperature of the coil 24 is detected by the temperature sensor 32, and in step P6, the controller 36 determines whether or not the temperature is less than the threshold T1.

In a case in which the temperature of the coil 24 is not less than the threshold value T1, the power supply to the Peltier element 30 is continued under the control of the controller 36, and step P4, step P5, and step P6 are repeated. Then, in step P6, in a case in which the controller 36 determines that the temperature is less than the threshold value T1, in step P7, power supply to the Peltier element 30 is stopped. Thereafter, in step P8, it is determined whether or not the ignition (IG) mode is continued or not (OFF), and if it is continued, the process repeats from step P1, and if it is OFF, the control is terminated.

As a result, according to the vehicle horn system 10 of the present embodiment, by controlling the power supply to the Peltier element 30 by the controller 36, it is possible to suppress an increase in the internal temperature of the horn 12. Therefore, in the sound (warning sound) generated from the horn 12, it is possible to suppress a decrease in sound pressure without causing a sound quality defect.

In particular, the Peltier element 30 is interposed between the housing 14 and the coil 24 which generates a magnetic force upon being supplied with power (the heat radiation side surface 30A of the Peltier element 30 contacts the housing 14, and the heat absorption side surface 30B of the Peltier element 30 contacts the coil 24). As a result, the coil 24 is efficiently heat-exchanged with the housing 14 and the outside air, and is cooled. In other words, an increase in the internal temperature of the horn 12 may be effectively suppressed, and a decrease in sound pressure may be effectively suppressed.

Furthermore, a temperature sensor 32 for this purpose is arranged at the opposite side from the Peltier element 30 with the coil 24 interposed therebetween. Therefore, as compared to a case in which the temperature sensor 32 is arranged on the same side as the Peltier element 30, the temperature necessary for securing the sound pressure may be appropriately detected. Further, since the controller 36 which controls the Peltier element 30 effects control so as to cool the horn 12 when the temperature of the coil 24 detected by the temperature sensor 32 becomes equal to or higher than a predetermined temperature (threshold value T1), the temperature required to secure the sound pressure may be efficiently controlled.

While the vehicle horn system 10 according to the present embodiment has been described above based on the drawings, the vehicle horn system 10 according to the present embodiment is not limited to that illustrated in the drawings, and the design may be appropriately changed within a scope that does not depart from the gist of the present disclosure. For example, the cooling part is not limited to the Peltier element 30. As the cooling part, for example, a cooling pipe of an air conditioner may be piped via the vicinity of the coil 24 to cool the coil 24, or cooling may be performed by another cooling method.

Furthermore, the vehicle in which the vehicle horn system 10 according to the present embodiment is installed is not limited to an electric vehicle. However, there are cases in which the size of the front grill is reduced in an electric vehicle in order to reduce the need for cooling the power unit room and reduce the air resistance, and in some cases, it becomes difficult to secure the sound pressure of sound transmitted from the horn 12 via a front grill. In the vehicle horn system 10 according to the present embodiment, since the sound pressure of sound may be effectively secured, it is particularly effective in an electric vehicle having a small front grill.

What is claimed is:

1. A vehicle horn system, comprising:
a horn provided at a vehicle; and
a cooling part that cools the horn.

2. The vehicle horn system according claim 1, wherein:
the horn comprises:
a housing; and
a coil that generates a magnetic force upon being supplied with electric power, and the cooling part is disposed between the housing and the coil.

3. The vehicle horn system according claim 2, wherein:
the cooling part comprises a Peltier element, and
a heat radiation side of the Peltier element contacts the housing, and a heat absorption side of the Peltier element contacts the coil.

4. The vehicle horn system according claim 2, further comprising:
a controller that is configured to control the cooling part; and
a temperature sensor that detects a temperature of the coil,
wherein the controller effects control so as to cool the horn in a case in which the temperature of the coil detected by the temperature sensor has become equal to or higher than a predetermined temperature.

5. The vehicle horn system according claim 4, wherein the temperature sensor is disposed at an opposite side of the coil from the cooling part.
